(19) United States
(12) Patent Application Publication
(10) Pub. No.: US 2009/0179023 A1
(43) Pub. Date: Jul. 16, 2009

(54) Ceramic heating elements having open-face structure and methods of fabrication thereof

(75) Inventors: Suresh Annavarapu, Somerville, MA (US); Ara Vartabedian, Hudson, MA (US); Dean Croucher, Sterling, MA (US)

Correspondence Address: Edwards Angell Palmer & Dodge LLP, P.O. Box 55874, Boston, MA, 02205, US

(73) Assignee: Saint-Gobain Ceramics & Plastics, INc., Worcester, MA (US)

(21) Appl. No.: 12/317,924

(22) Filed: Dec. 29, 2008

Related U.S. Application Data
(60) Provisional application No. 61/009,508, filed on Dec. 29, 2007.

(51) Int. Cl. F23Q 7/00; H05B 3/00

(52) U.S. Cl. 219/260; 29/611

(57) ABSTRACT

The invention provides new ceramic resistive heating elements and new methods for manufacturing ceramic resistive heating elements wherein the heating element body comprises two or more regions of differing resistivity, and wherein the heating elements are open face. Heating elements such as igniters and glow plugs also are provided obtainable from fabrication methods of the invention.

The present application claims the benefit of U.S. provisional application No. 61/009,508 filed Dec. 29, 2007, which is incorporated by reference herein in its entirety.

### BACKGROUND

1. Field

The invention includes new ceramic resistive heating elements comprising two or more regions of differing resistivity, particularly open faced heating elements. The invention further includes new methods for manufacture of ceramic resistive heating elements that include forming a heating element body comprising two or more regions of differing resistivity, and processing a portion of the element body to form a heating element, wherein the heating element has an open face structure. Heating elements such as igniters and glow plugs also are provided obtainable from fabrication methods of the invention.

2. Background

Ceramic materials have enjoyed great success as igniters in e.g. gas-fired furnaces, stoves and clothes dryers. Ceramic igniter production includes constructing an electrical circuit through a ceramic component a portion of which is highly resistive and rises in temperature when electrified by a wire lead. See, for instance, U.S. Pat. Nos. 6,582,629; 6,278,087; 6,028,292; 5,801,361; 5,786,565; 5,405,237; and 5,191,508.

Typical igniters have been generally rectangular-shaped elements with a highly resistive “hot zone” at the igniter tip with one or more conductive “cold zones” providing to the hot zone from the opposing igniter end. One currently available igniter, the Mini-Igniter™, available from Norton Igniter Products of Milford, N.H., is designed for 12 volt through 120 volt applications and has a composition comprising aluminum nitride (“AlN”), molybdenum disilicide (“MoSi₂”), and silicon carbide (“SiC”).

Igniter speed (i.e., the time it takes to heat up from room temperature to fuel ignition temperature e.g. 1350° C., also referred to as “time to temperature” (TTT)) is an important performance characteristic. In particular, it is desirable that an igniters have a TTC of less than 3 seconds, but many current devices are not capable of such rapid heating.

Heating elements also can undergo undesirable oxidation. To address this problem, laminated igniters, such as tungsten carbide (WC) encapsulated by Si₃N₄, have been developed to protect the heating element (e.g., WC) from the atmosphere and, thus, provide resistance to oxidation. However, heat transfer from the encapsulated heating element to the insulating material limits the speed/TTT because the heating element must heat up the insulating zone for ignition.

Further, current ceramic igniters also have suffered from breakage during use, particularly in environments where impacts may be sustained such as igniters used for gas cooktops and the like.

It thus would be desirable to have new ignition systems. It would further be desirable to have new methods for producing ceramic igniters, wherein the igniters are provided with good mechanical integrity, resistance to undesirable oxidation, and faster speed (i.e., TTT).

### SUMMARY

New ceramic heating elements are now provided which include two or more regions of differing resistivity, particularly open faced heating elements wherein at least one side of the element is exposed to the atmosphere. New methods for producing ceramic heating elements are also provided which include forming a heating element body comprising two or more regions of differing resistivity wherein the heating element has an open face structure.

In one aspect, the invention generally relates to a method for producing a resistive ceramic heating element by forming a heating element body comprising an inner region and an outer region, wherein the inner region and outer region have differing resistivities and wherein the inner region is substantially encapsulated by the outer region, and processing the heating element body so as to expose at least a portion of the inner region and thereby define an electrical pathway exposed to the atmosphere.

Embodiments according to this aspect of the invention can include the following features. The inner region can comprise at least one insulator material and the outer region can comprise at least one conductive material. As such, exposure of at least a portion of the inner insulator region separates the outer conductive region, thereby providing an electrical pathway on the outer conductive region. At least a further portion of the inner insulator layer can be exposed to lengthen the electrical pathway. Lengthening of the electrical pathway can provide higher operational voltages. One or more further regions of differing resistivity can be provided within the electrical pathway to thereby define one or more cold zones and one or more hot zones. Processing can comprise removing one or more portions of the outer region. The heating element body can be formed with one or more protruding sections, and processing can comprise removing one or more protruding sections of the heating element body. The heating element can have a substantially square or rectangular cross-sectional shape for at least a portion of the heating element length. The inner region can be exposed so as to form a serpentine electrical pathway on at least a top surface of the heating element. The inner region can be exposed so as to form a serpentine electrical pathway on the bottom surface of the heating element. The inner region can be exposed along a portion of at least one side surface to provide an electrical pathway that extends from the top surface to the bottom surface.

In another aspect, the invention generally relates to a method for increasing the time to temperature (TTT) time of an encapsulated heating element by forming a heating element body comprising an inner region and an outer region, wherein the inner region and outer region have differing resistivities and wherein the inner region is substantially encapsulated by the outer region, and processing the heating element body so as to expose at least a portion of the inner region, thereby defining an electrical pathway exposed to the atmosphere.

In another aspect, the invention generally relates to a method for producing a resistive ceramic heating element by forming a base region, the base region having a first resistivity, depositing a heating element pattern on one or more surfaces of the base region, filling the pattern with a material having a second resistivity different than the first resistivity, whereby an electrical pathway is defined by the pattern of material having the second resistivity separated by the base region material having the first resistivity, and whereby the electrical pathway is exposed to the atmosphere.

Embodiments according to this aspect of the invention can include the following features. The base region can be formed of at least one insulator material and the pattern can be formed of at least one conductive material, wherein the pattern defines the electrical pathway. The heating element pattern can be deposited by embossing. The pattern can be filled with a slurry and processed to provide a surface pattern disposed on the base region.

In another aspect, the invention generally relates to a heating element body comprising an inner region having a first resistivity, an outer region substantially encapsulating the inner region, the outer region having a second resistivity, wherein at least portions of the inner region are exposed on one or more surfaces of the heating element body, thereby defining an electrical pathway exposed to the atmosphere.

Embodiments according to this aspect of the invention can include the following features. The inner region can be formed of at least one insulator material and the outer region can be formed of at least one conductive material, wherein the outer region is separated by the exposed inner region to thereby define the electrical pathway.

In another aspect, the invention generally relates to a heating element body comprising a base region having a first resistivity, a surface pattern disposed on at least one surface of the base region, the surface pattern having a second resistivity, wherein an electrical pathway is defined on at least one surface of the heating element body by the differing resistivities in the base region and the surface pattern.

Embodiments according to this aspect of the invention can include the following features. The base region can be formed of an insulator material and the surface pattern is formed of a conductive material, and wherein the electrical pathway is defined on the surface pattern. The base region can be provided with two or more independent electrical pathways with different characteristics. Independent electrical pathways can be provided on different surfaces of the base region.

In another aspect, the invention generally relates to a heating element body comprising two or more regions of differing resistivities and two or more independent electrical pathways, wherein the two or more electrical pathways are provided with different characteristics.

Embodiments according to this aspect of the invention can include the following features. The heating element body can comprises an inner region and an outer region, the inner region and outer region have differing resistivities, the inner region substantially encapsulated by the outer region, wherein at least a portion of the inner region is exposed thereby defining two or more independent electrical pathway exposed to the atmosphere. The heating element can have a rectangular shape and independent electrical pathways can be disposed on different surfaces of the heating element. The different characteristics of the electrical pathways can be provided by the number and/or positioning of the exposed inner regions. The different characteristics of the electrical pathways can be provided by the presence or absence of hot and cold zones.

In another aspect, the invention generally relates to a method of igniting gaseous fuel, comprising applying an electric current across a heating element in accordance with any of the embodiments set forth herein.

Embodiments according to this aspect of the invention can include the following features. The current can have a nominal voltage of 6, 8, 9, 10, 12, 24, 120, 220, 230 or 240 volts.

In another aspect, the invention generally relates to a heating apparatus comprising a heating element in accordance with any of the embodiments set forth herein.

Other aspects of the invention are disclosed infra.

### BRIEF DESCRIPTION OF THE DRAWINGS

FIG. 1A shows one embodiment of a heating element of the invention.

FIG. 1B shows the direction of an electrical pathway on the heating element of FIG. 1A.

FIG. 1C shows a perspective view of the top surface of the heating element of FIG. 1A.

FIG. 1D shows a perspective view of one embodiment of a bottom surface of the heating element of FIG. 1A.

FIG. 1E shows a perspective view of another embodiment of a bottom surface of the heating element of FIG. 1A.

FIG. 1F shows another embodiment of a heating element of the invention having a “hot zone” and “cold zones”.

FIG. 1G shows a detailed view of the heating element of FIG. 1F wherein the bridge height of the “hot zone” is depicted.

FIG. 2 shows another embodiment of a heating element of the invention having a tapered distal region.

FIG. 3A shows another embodiment of a heating element of the invention having additional portions of an inner region exposed at one or more side-faces.

FIG. 3B shows the direction of an electrical pathway on the heating element of FIG. 3A.

FIG. 4A shows another embodiment of a heating element of the invention having additional portions of an inner region exposed at one or more side-faces.

FIG. 4B shows the direction of an electrical pathway on the heating element of FIG. 4A.

FIG. 5 shows another embodiment of a heating element of the invention having an inner region exposed at the top and bottom and side-faces, as well as the direction of an electrical pathway of the heating element.

FIG. 6A shows a perspective view of another embodiment of a heating element of the invention.

FIG. 6B shows a cross-sectional view of the heating element of FIG. 6A along 3-3.

FIG. 7A-C shows a perspective view of process steps to produce a heating element in accordance with one embodiment of the invention.

FIG. 8A-C shows a cross-sectional view of process steps to produce a heating element in accordance with another embodiment of the invention.

FIG. 9A-D shows a cross-sectional view of process steps to produce a heating element in accordance with another embodiment of the invention.

FIG. 10A-B shows a perspective view of process steps to produce a heating element in accordance with another embodiment of the invention.

FIG. 11 A-B shows a longitudinal section view of process steps to produce a heating element in accordance with another embodiment of the invention.

FIG. 12 A-F shows process steps of a further fabrication sequences in accordance with another embodiment of the invention. FIG. 12B is a view along 4-4 of FIG. 12A. FIG. 12 D-F are views along 5-5 of FIG. 12C.

### DETAILED DESCRIPTION

As discussed above, new ceramic heating elements and methods for manufacture are provided. The heating elements include two or more regions of differing resistivity. In certain embodiments, the heating elements are “open face” heating elements. As used herein, “open face” refers to a structure wherein the functional surface, also called the electrical circuit, is at least partially exposed to the atmosphere.

As referred to herein, the term “insulator” or “electrically insulating material” indicates a material having a room temperature resistivity of at least about 10¹⁰ ohms-cm. The electrically insulating material component of heating elements of the invention may be comprised solely or primarily of one or more metal nitrides and/or metal oxides, or alternatively, the insulating component may contain materials in addition to the metal oxide(s) or metal nitride(s). For instance, the insulating material component may additionally contain a nitride such as aluminum nitride (AlN), silicon nitride, SiALON, or boron nitride; a rare earth oxide (e.g. yttria); or a rare earth oxynitride.

As referred to herein, a semiconductor ceramic (or “semiconductor”) is a ceramic having a room temperature resistivity of between about 10 and 10⁸ ohm-cm. If the semiconductive component is present as more than about 45 v/o of a hot zone composition (when the conductive ceramic is in the range of about 6-10 v/o), the resultant composition becomes too conductive for high voltage applications (due to lack of insulator). Conversely, if the semiconductor material is present as less than about 5 v/o (when the conductive ceramic is in the range of about 6-10 v/o), the resultant composition becomes too resistive (due to too much insulator). Again, at higher levels of conductor, more resistive mixes of the insulator and semiconductor fractions are needed to achieve the desired voltage. Typically, the semiconductor is a carbide from the group consisting of silicon carbide (doped and undoped), and boron carbide.

As referred to herein, a “conductive material” is one which has a room temperature resistivity of less than about 10⁻² ohm-cm. If the conductive component is present in an amount of more than 35 v/o of the hot zone composition, the resultant ceramic can become too conductive. Typically, the conductor is selected from the group consisting of molybdenum disilicide, tungsten disilicide, and nitrides such as titanium nitride, and carbides such as titanium carbide. Molybdenum disilicide is generally preferred.

For any of the ceramic compositions (e.g. insulator, conductive material, semiconductor material, resistive material), the ceramic compositions may comprise one or more different ceramic materials (e.g. SiC, metal oxides such as Al₂O₃, nitrides such as AlN, Mo₂Si₂ and other Mo-containing materials, SiAlON, Ba-containing material, and the like). Alternatively, distinct ceramic compositions (i.e. distinct compositions that serve as insulator, conductor and resistive (ignition) zones in a single heating element) may comprise the same blend of ceramic materials (e.g. a binary, ternary or higher order blend of distinct ceramic materials), but where the relative amounts of those blend members differ, e.g. where one or more blend members differ by at least 5, 10, 20, 25 or 30 volume percent between the respective distinct ceramic compositions.

A variety of compositions may be employed to form a heating element of the invention. Generally preferred hot zone compositions comprise at least three components of 1) conductive material; 2) semiconductive material; and 3) insulating material. Conductive (cold) and insulative (heat sink) regions may be comprised of the same components, but with the components present in differing proportions, as mentioned above. Typical conductive materials include e.g. molybdenum disilicide, tungsten disilicide, nitrides such as titanium nitride, and carbides such as titanium carbide. Typical semiconductors include carbides such as silicon carbide (doped and undoped) and boron carbide. Typical insulating materials include metal oxides such as alumina or a nitride such as AlN and/or Si₃N₄.

In general, preferred hot (resistive) zone compositions include (a) between about 50 and about 80 v/o of an electrically insulating material having a resistivity of at least about 10¹⁰ ohm-cm; (b) between about 5 and about 45 v/o of a semiconductive material having a resistivity of between about 10 and about 10⁸ ohm-cm; and (c) between about 5 and about 35 v/o of a metallic conductor having a resistivity of less than about 10⁻² ohm-cm. Preferably, the hot zone comprises 50-70 v/o electrically insulating ceramic, 10-45 v/o of the semiconductive ceramic, and 6-16 v/o of the conductive material. A specifically preferred hot zone composition for use in heating elements of the invention contains 10 v/o MoSi₂, 20 v/o SiC and balance AlN or Al₂O₃.

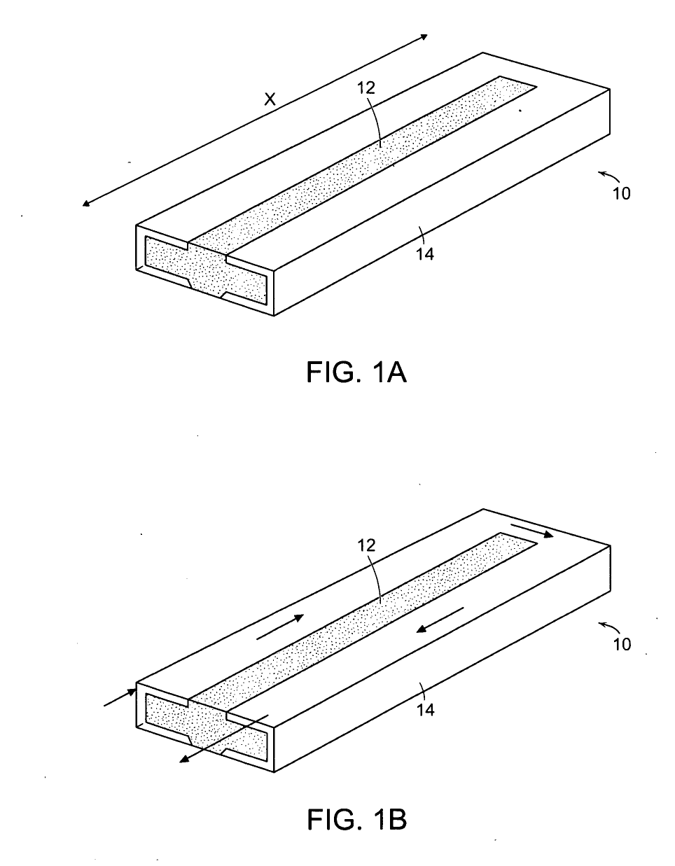

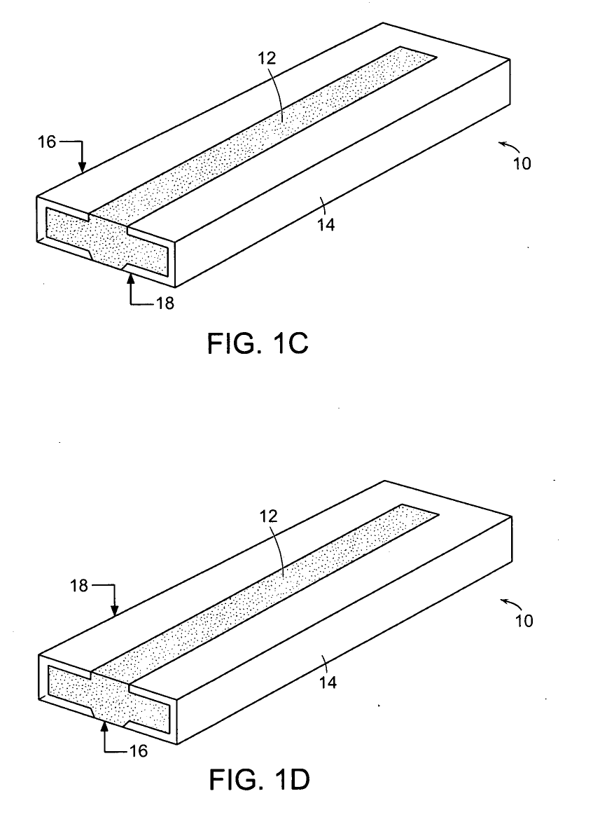

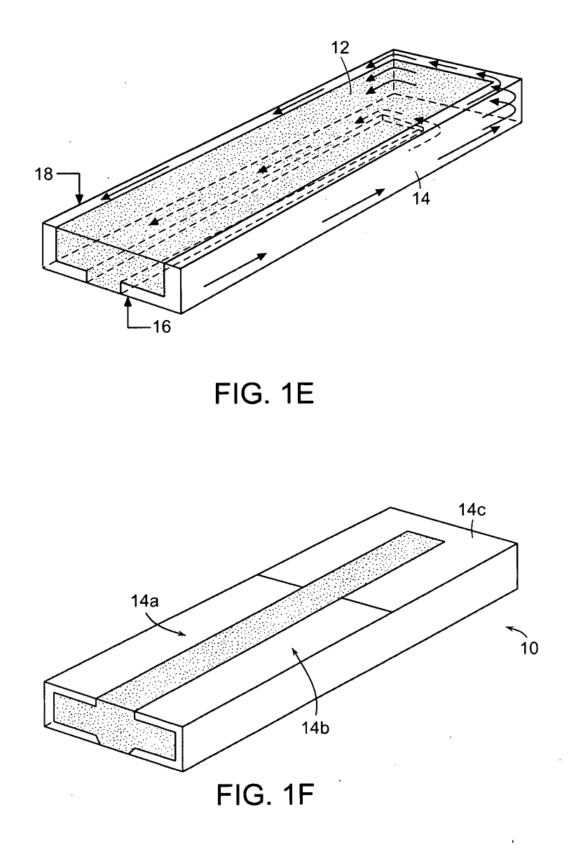

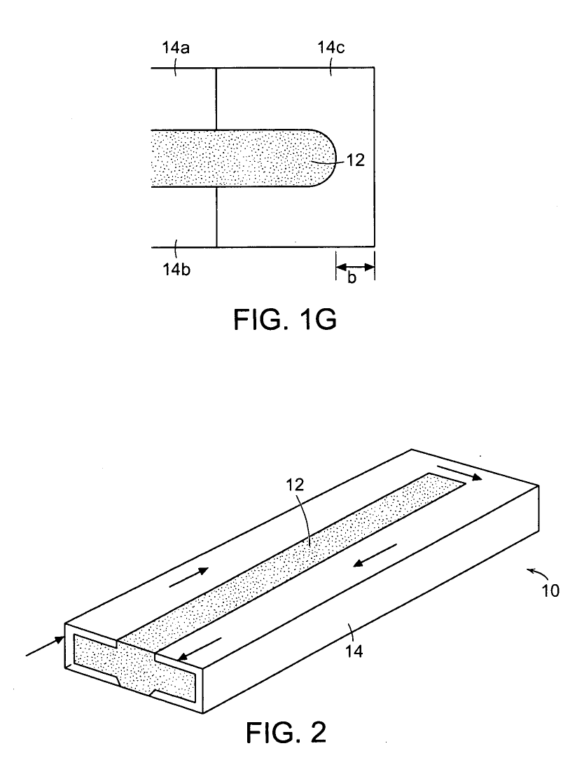

Referring now to the drawings, FIGS. 1A-1G shows one embodiment of a heating element 10 which includes two regions (12, 14) of differing resistivity. In an exemplary embodiment as shown in FIGS. 1A-1G, an inner insulator region 12 is provided with an outer conductive region 14. Alternately, the inner region 12 can be conductive, while the outer region 14 can be an insulator. As shown, the inner insulator region 12 is exposed to separate an outer conductive region 14 such that the outer conductive region 14 defines an electrical circuit. The direction of the electrical pathway (depicted by the arrows) is shown in FIG. 1B.

In some embodiments, the top surface 16 and the bottom surface 18 of the heating element 10 can be identical and provide identical electrical pathways, for example, as shown in FIGS. 1C and 1D. In other embodiments, the top surface 16 and the bottom surface 18 of the heating element 10 can be different, for example, as shown in FIGS. 1C and 1E. It is to be understood that the bottom surface 18, when different than the top surface 16, can have different configurations than that shown in FIG. 1E. For example, while FIG. 1E shows the bottom surface 18 with inner region 12 mostly exposed, the bottom surface 18 can have one or more portions of region 12 exposed in configurations different than those exposed on the top surface 16.

In some embodiments, the inner and/or outer region 12/14 can be formed to have zones of differing resistivity. Thus, for example, the outer region 14 can be formed of a first material having a first resistivity and a second material having a second resistivity. In an exemplary embodiment, the heating element is be formed to have one or more electrical circuits or pathways wherein the pathway includes at least one or more low resistivity cold zones in electrical connection with one or more hot zones. In one embodiment shown in FIG. 1F, region 14 has “cold zones” 14a, 14b and a “hot zone” 14c, wherein the hot zone 14c is formed of a material having a greater resistivity than the material forming the cold zones 14a, 14b. The material forming each of the cold zones 14a, 14b is typically the same, but, if desired, material forming zone 14a can be different than that forming zone 14b to provide further zones of differing resistivity. Typically, a hot zone 14c is disposed between two cold zones 14a, 14b, as shown in FIG. 1F. In this embodiment, the hot zone 14c has a non-linear, substantially U-shaped electrical path that extends down the length of each side of the heating element. Such non-linear hot zone geometries are desirable because they are believed to more effectively diffuse power density throughout the hot zone region, and to enhance operational life of the heating element. In this embodiment, the dimensions of the hot zone 14c may suitably vary, and, in general, the overall hot zone 14c electrical path length should be sufficient to avoid electrical shorts or other defects. The hot zone 14c bridge height (depicted as distance “b” in FIG. 1G) also should be of sufficient size to avoid igniter defects, including excessive localized heating, which can result in igniter degradation and failure. The composition of the hot zone 14c and cold zones 14a, 14b may suitably vary; however, suitable compositions for those regions are disclosed in U.S. Pat. No. 5,786,565 to Willkens et al. as well as in U.S. Pat. No. 5,191,508 to Axelson et al.

In some embodiments, wherein the top and bottom surfaces 16, 18 each have an exposed or open face electrical pathway, the top and/or bottom surfaces 16, 18 can have one or more hot and cold zones. These hot and cold zones on the top and bottom surfaces 16, 18 can have identical configurations or they can have different configurations on each of the surfaces 16, 18.

In some embodiments, the inner and/or outer regions 12/14 can be provided with zones of differing resistivity by tapering one or more portions of the heating element along its electrical pathway. For example, as shown in FIG. 2, in some embodiments, the heating element can have a generally rectangular shape that tapers at its distal region 40 (decreased cross-sectional area). The decrease in cross-sectional area provides greater resistance in that region of the electrical pathway.

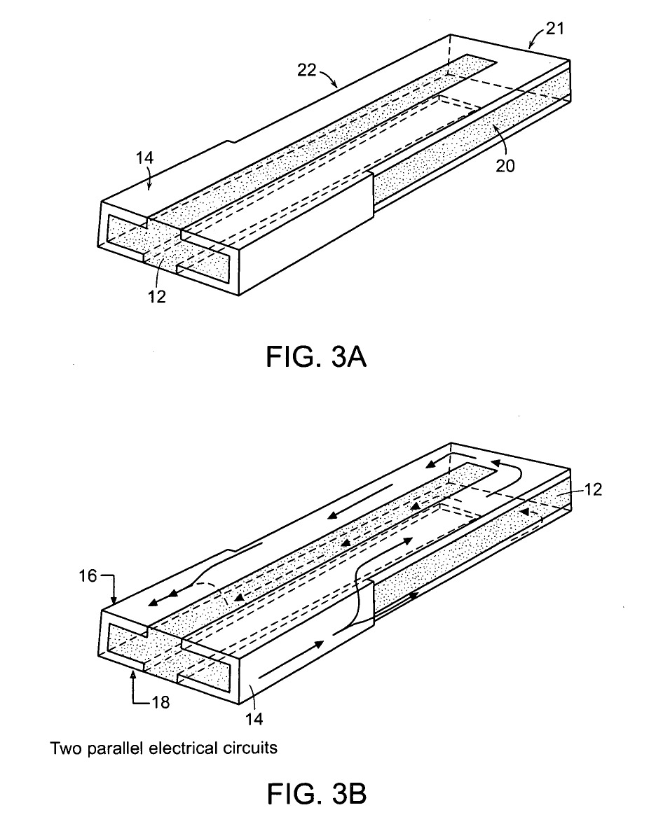

FIGS. 3A-3B show another embodiment of a heating element 10 which includes multiple regions (12, 14) of differing resistivity. This embodiment is similar to that shown in FIGS. 1A-1F except one or more additional portions of the inner region 12 are exposed along one or more surfaces of the heating element. In one embodiment, shown in FIG. 3A, the inner region 12 is further exposed along a portion of side-faces 20, 21 and 22.

As shown in FIGS. 3A-3B, the exposed portions of the inner region 12 separate an outer conductive region 14 thereby defining an electrical circuit. The direction of the electrical pathway (depicted by the arrows) is shown in FIG. 3B. By exposing the side-faces 20, 21 and 22, two parallel electrical pathway run on the top surface 16 and bottom surface 18 higher operational voltages can be provided (e.g. as compared with the electrical pathway of FIG. 1B).

In the embodiments of FIGS. 3A-3B, the configurations (e.g. configuration of exposed inner region 12) of the top and bottom surfaces 16, 18 can be identical or different, as with the embodiments described in connection with FIGS. 1A-1F. Further, the embodiments of FIGS. 3A-3B can also be provided with one or more exposed electrical pathways comprising one or more hot zones and one or more cold zones. In embodiments wherein both the top and bottom surfaces 16, 18 have exposed electrical pathways each having one or more hot zones and one or more cold zones, the configurations of the hot and cold zones on the top and bottom surfaces 16, 18 can be identical or different. Further, the embodiments of the heating element in FIGS. 3A-3B can be tapered at its distal region (decreased cross-sectional area), thereby providing greater resistance in that region of the electrical pathway.

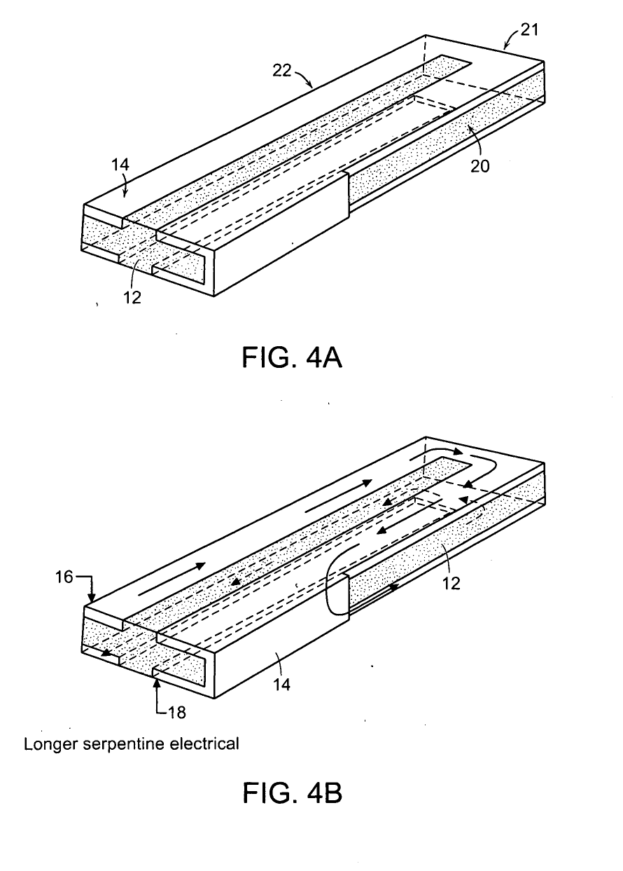

FIGS. 4A-4B show another embodiment of a heating element 10 which includes multiple regions (12, 14) of differing resistivity. In this embodiment, the inner region 12 is exposed at side-faces 20, 21 and 22, thereby causing the electrical pathway to run to the bottom surface and, thus, defining a longer serpentine electrical pathway (depicted by the arrows in FIG. 4B and, thus, providing higher operational voltages (e.g. as compared with the pathway of FIGS. 1A-1B).

In the embodiments of FIGS. 4A-4B, the configurations (e.g. configuration of exposed inner region 12) of the top and bottom surfaces 16, 18 can be identical or different, as with the embodiments described in connection with FIGS. 1A-1F. Further, the embodiments of FIGS. 4A-4B can also be provided with one or more exposed electrical pathways comprising one or more hot zones and one or more cold zones. In embodiments wherein both the top and bottom surfaces 16, 18 have exposed electrical pathways each having one or more hot zones and one or more cold zones, the configurations of the hot and cold zones on the top and bottom surfaces 16, 18 can be identical or different. Further, the embodiments of the heating element in FIGS. 4A-4B can be tapered at its distal region (decreased cross-sectional area) or at other portions of the heating element length, thereby providing greater resistance in that region of the electrical pathway.

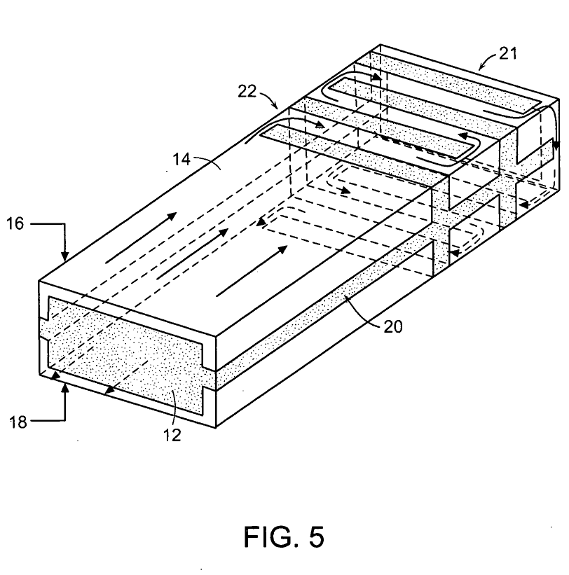

FIG. 5 shows another embodiment of a heating element 10 which includes multiple regions (12, 14) of differing resistivity. In this embodiment, one or more portions of the inner region 12 are exposed along one or more surfaces of the heating element to form another type of serpentine pathway. For example, as shown, the inner region 12 is exposed along portions of side-face 20 and top surface 16. One or more portions of the opposite side-face 22 and bottom surface 18 can also be similarly exposed, if desired. The direction of the electrical pathway (depicted by the arrows) is shown in FIG. 5. By exposing the side-face 20, the electrical pathway runs to the bottom surface 18 and, thus, is further lengthened. As a result of the lengthened pathway, higher operational voltages can be provided (e.g. as compared with the electrical pathway of FIG. 4B).

In the embodiment of FIG. 5, the configurations (e.g. configuration of exposed inner region 12) of the top and bottom surfaces 16, 18 can be identical or different, as with the embodiments described in connection with FIGS. 1A-1F. Further, the configuration of the two side-faces 20, 22 can be identical or different. The embodiment of FIG. 5 can also be provided with one or more exposed electrical pathways comprising one or more hot zones and one or more cold zones. In embodiments wherein both the top and bottom surfaces 16, 18 have exposed electrical pathways each having one or more hot zones and one or more cold zones, the configurations of the hot and cold zones on the top and bottom surfaces 16, 18 can be identical or different. Further, in embodiments wherein both side-faces 20, 22 have exposed electrical pathways each having one or more hot zones and one or more cold zones, the configurations of the hot and cold zones on the side-faces 20, 22 can be identical or different. Further, the embodiments of the heating element in FIGS. 5A-5B can be tapered at its distal region (decreased cross-sectional area) or at other portions of the heating element length, thereby providing greater resistance in that region of the electrical pathway.

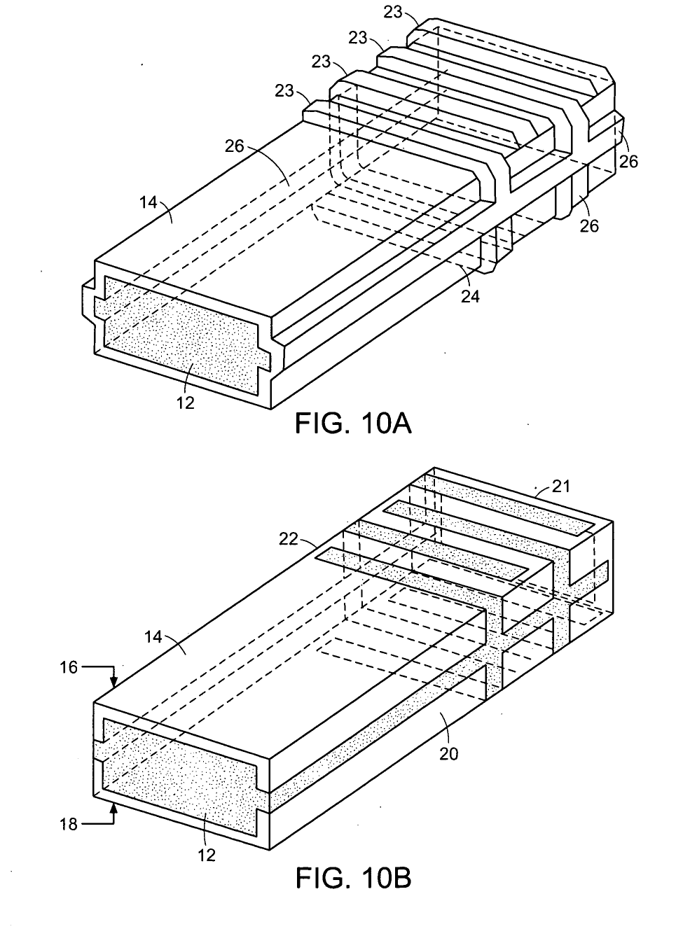

It is noted that while the figures generally show protrusions running along the lengths of the top and bottom surfaces 16, 18 and side-faces 20, 22, and in many cases along the center lengths of these faces, one or more protrusions can be positioned at locations other than along the center of these faces 16, 18, 20, 22 and/or running in directions other than along the lengths of these faces 16, 18, 20, 22 (e.g. as shown in FIGS. 5, 10A, 10B). Further, various numbers or exposed inner regions 12 can be provided in one or more surfaces of the heating element 10 (e.g., top, bottom, and side surfaces) to provide any desired electrical pathway. For example, any other conventional electrical pathway configurations can be provided, such as, for example, helical pathways. As with serpentine pathways, a lengthened pathway is provided by using a helical configuration and, thus, higher operational voltages can be provided.

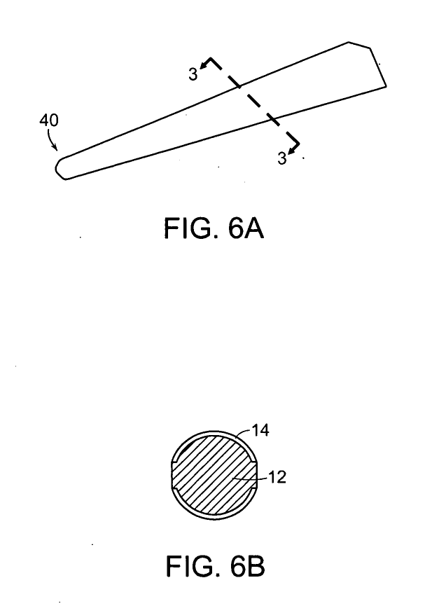

The present heating elements include any variety of geometric shapes in addition to the generally rectangular shapes set forth in connection with FIGS. 1A-5. For example, the heating element can have a rod-like shape such as that shown in FIGS. 6A-6B, wherein 6B and 9A-D shows the cross-section of FIG. 6A along 3-3 of FIG. 6A. As shown. An inner insulator region 12 is exposed at one or more locations to separate outer conductive region 14 into, e.g. sections 30A, 30B or 31A, 31B, 31C, and 31D, thereby forming an electrical pathway. For example, a plurality of portions of the inner insulator region 12 can be exposed to provide a serpentine electrical pathway along the outer conductive region 14 (much like that shown, for example, in FIGS. 4A-5). Any number of portions and configurations of inner regions 12 can be exposed so as to provide the desired pathway. In some embodiments, helical and other shaped pathways can be provided about the heating element by appropriate exposure of the inner region 12. While the embodiment shows the distal end 40 tapering, other tapering configurations can be used, or the cross-section of the rod-shaped heating element can be devoid of a taper or provided with a substantially constant cross section along its length. The rod-shaped embodiment can, further, be provided with any of the features set forth in connection with the rectangular shaped elements. In some embodiments, a generally uniform or regular electrical pathway is provided along the entire outer surface of the rod-shaped element. In some embodiments, the electrical pathway is provided only on one side of the rod-shaped element or is provided in a random or varying pattern (e.g. by exposing the inner region 12 differently along the outer surface). In some embodiments, more than one separate electrical pathway is provided on different portions of the inner region 12 surface. Further, one or more of the exposed electrical pathways can be provided with one or more hot zones and one or more cold zones.

Dimensions of heating elements of the invention may vary widely and may be selected based on intended use of the heating element. For instance, the length of a preferred heating element (length x in FIG. 1A) suitably may be from about 0.5 to about 5 cm or more, more preferably from about 1 about 3 cm, and the heating element cross-sectional width may suitably be from about 0.2 to about 3 cm.

In certain preferred systems, the hot or resistive zone of a heating element of the invention will heat to a maximum temperature of less than about 1450° C. at nominal voltage; and a maximum temperature of less than about 1550° C. at high-end line voltages that are about 110 percent of nominal voltage; and a maximum temperature of less than about 1350° C. at low-end line voltages that are about 85 percent of nominal voltage.

The materials used to form the various parts of the heating elements can be selected from any conventional materials. In some embodiments, suitable insulator materials can be made of any conventional insulator materials and, in certain embodiments, are those having high temperature oxidation resistance in air (1300-1500° C.). Some examples of suitable insulating materials include, but are not limited to, metal oxides such as alumina or a nitride such as Al₂O₃, AlN, SiALON (i.e. a silicon aluminum oxynitride material) and/or Si₃N₄ (e.g., with rare earth addition). Use of insulating materials having a high strength (e.g. 400 Mpa or higher) can provide increased ruggedness. Some typical conductive materials include, e.g. molybdenum disilicide, tungsten disilicide, nitrides such as titanium nitride, and carbides such as titanium carbide. In certain embodiments, if a separate ceramic composition is employed to form a hot zone region, generally preferred hot zone compositions comprise at least three components of 1) conductive material; 2) semiconductive material; and 3) insulating material. Typical semiconductor materials, when utilized, include carbides such as silicon carbide (doped and undoped) and boron carbide.

In general, if employed, suitable hot (resistive) zone compositions include (a) between about 50 and about 80 v/o of an electrically insulating material having a resistivity of at least about 1010 ohm-cm; (b) between about 5 and about 45 v/o of a semiconductive material having a resistivity of between about 10 and about 10⁸ ohm-cm; and (c) between about 5 and about 35 v/o of a metallic conductor having a resistivity of less than about 10⁻² ohm-cm. Preferably, the hot zone comprises 50-70 v/o electrically insulating ceramic, 5-45 v/o of the semiconductive ceramic, and 5-20 v/o of the conductive material.

Preferred cold zone (conductive) regions include those that are comprised of e.g. AlN and/or Al₂O₃ or other insulating material; SiC or other semiconductor material; and MoSi₂ or other conductive material.

In any of the embodiments of the present heating elements, more than one electrical pathway can be provided on a given heating element. For example, a rectangular shaped heating element can have a first electrical pathway provided on one surface with specific characteristics. These specific characteristics can be provide based on, e.g. the number and positioning of the exposed inner regions 12, tapering of the heating element along the pathway length, and/or providing one or more hot and cold zones along the pathway length. The same heating element can further have one or more additional independent electrical pathways provided on one or more further surfaces having specific characteristics different than those of the first electrical pathway. As such, a single heating element can be used in any variety of applications and can provide the required characteristics for any number of applications simply by selecting the appropriate electrical pathway to use. A plurality of independent electrical pathways similarly can be provided on any geometry including the rod-shaped heating elements as well as others (e.g. heating elements having oval, triangular, hexagonal, etc. shaped cross-sections).

New methods for forming ceramic heating elements are further provided. In particular, new methods for forming open face ceramic heating elements are provided.

In one general embodiment, methods include forming an inner region 12, coating the inner region 12 with an outer region 14, and processing to expose one or more portions of the inner region. In particular, one or more portions of the inner region are exposed to thereby define an electrical pathway on one or more surfaces of the heating element. The inner region 12 and outer region 14 are provided such that they have differing resistivities. For example, the inner region 12 can be formed with an insulator material while the outer region 14 can be formed of a conductive material, and vice versa. As such, upon exposure of one or more portions of the inner region 12, the outer region 14 is separated by the inner region 12 to thereby define an electrical pathway. In some embodiments, the inner region 12 can, itself, have zones of differing resistivity, and/or the outer region 14, itself, be provided with zones of differing resistivities. Sintering may be performed before or after such processing to define the electrical pathway.

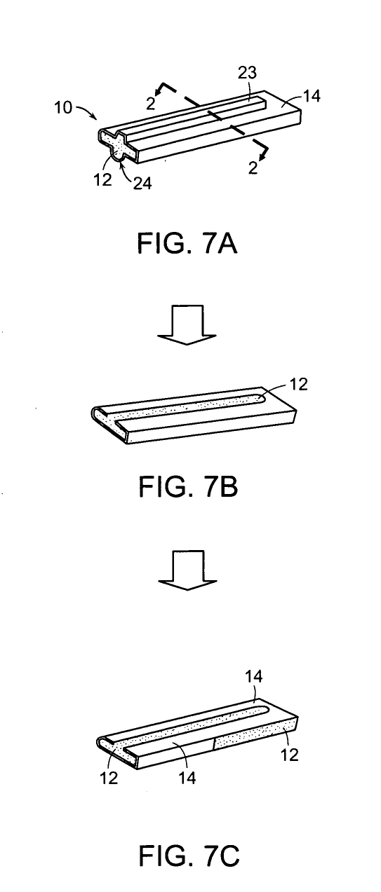

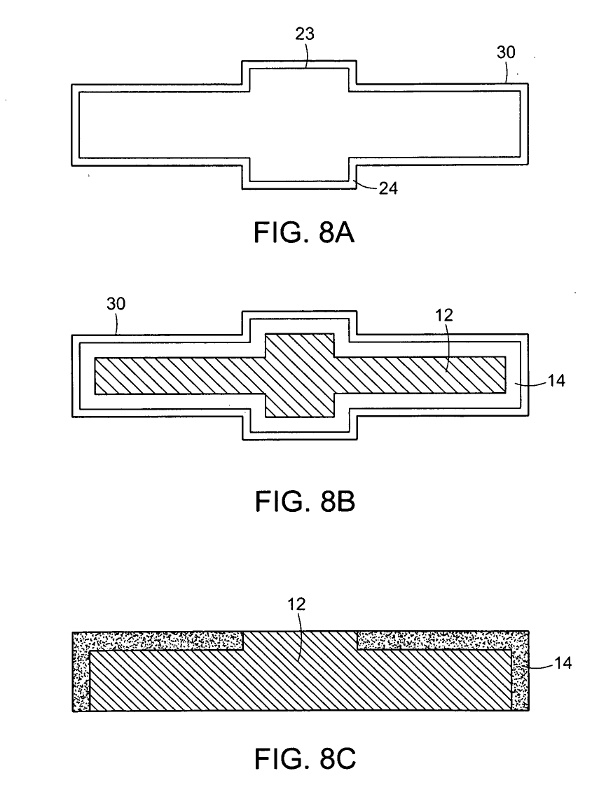

FIG. 7 shows one exemplary embodiment of a method for forming the heating element of FIGS. 1A-1F and 2A-2B. FIGS. 8A-C illustrate the cross-sectional view of this method (such as along 2-2 of FIG. 4). In this embodiment, a slip case mold 30 can be utilized of the general depicted configuration to provide a generally rectangular-shaped heating element body 10 with opposed protruding regions 23 and 24, as shown in FIG. 8B (extrusion and other methods can also be used to form the element body). In one system, the slip cast mold 20 can be filled with an insulator ceramic composition to form an inner insulator region 12. The inner region 12 can then be densified to form a rigid element, for example, by the removal of binding agent(s).

As generally illustrated in FIG. 8B, a conductive composition then can be applied around the slip cast insulator inner region 12 to form a conductive outer region 14. The conductive composition may be applied e.g. by another slip casting application or other means such as dip coating to thereby form a heating element 10 with two regions (12, 14) of differing resistivity.

As shown by FIGS. 7B and 8C one or more of the protruding regions 23, 24 then can be removed such as by machining to expose the inner region. Such processing of the element body may be done with the element body in a green or sintered state. Processing of regions 23 and 24 exposes the insulator inner region 12 which thereby bisects separated conductive zones 30A and 30B to define an electrical pathway. In use, current can flow the length of heating element through the conductive zone 30A and then back down the length of the heating element through conductive zone 30B. This electrical pathway is shown, for example in FIG. 1B. In some embodiments, for example, as shown and discussed in connection with FIGS. 1F-1G, the electrical pathway includes one or more cold zones 14a, 14b, and one or more hot zones 14c through which the current flows.

In some embodiments, one or more sides of the heating element body can be processed to expose the inner region 12 further. For example, one or more side-faces 20, 21, 22 of the element body can be processed to remove one or more portions of the outer region 14 as shown in FIGS. 3A-3B.

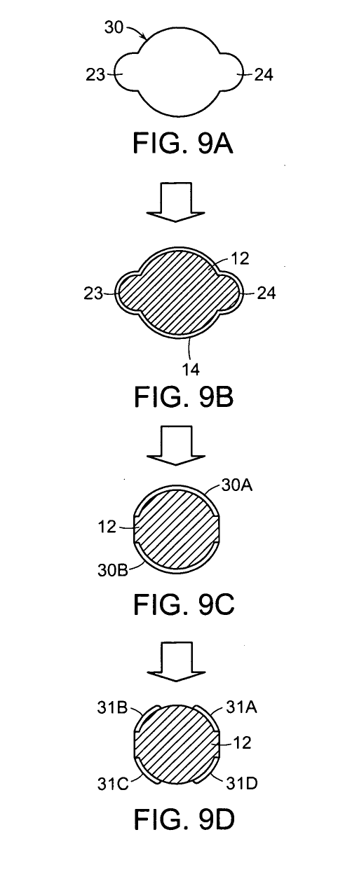

The method can similarly be used to form the heating elements shown in FIGS. 6A-6B. In particular, as shown in FIG. 9A a slip cast mold 30 can be utilized of the general depicted configuration to provide a rod-shaped heating element body with opposed protruding regions 23 and 24. In one system, the slip cast mold 30 can be filled with an insulator ceramic composition. A rigid element may be provided by removal of binding agent(s). As generally illustrated in FIG. 9B, an encasing conductive outer layer 14 then can be applied around the slip cast insulator region 12. That conductive outer layer 14 may be applied e.g. by another slip casting application or other means such as dip coating to thereby form a heating element with two regions (12, 14) of differing resistivity. As shown by FIG. 9C, protruding regions 23 and 24 then can be removed such as by machining to define an electrical pathway and provide a functional heating element. Such processing of the element body may be done with the element body in a green or sintered state. By processing of regions 23 and 24, particularly removal thereof, the insulator inner region 12 bisects separated conductive outer region 30A and 30B which define an electrical pathway. In use, current can flow the length of heating element through conductive zone 30A and then back down the length of the heating element through conductive zone 30B. In some embodiments, for example, as shown and discussed in connection with FIGS. 1F-1G, the electrical pathway includes one or more cold zones 14a, 14b, and one or more hot zones 14c through which the current flows. In some embodiments, the heating element is tapered at its distal end to provide increased resistance at that portion of the electrical pathway. In some embodiments, one or more additional portions of the heating element body can be processed to expose the inner region 12 further. Exposure of one or more additional portions of the inner region 12 can, for example, provide for a longer electrical pathway and, in some embodiment, can provide a heating element with a plurality of independent electrical pathways.

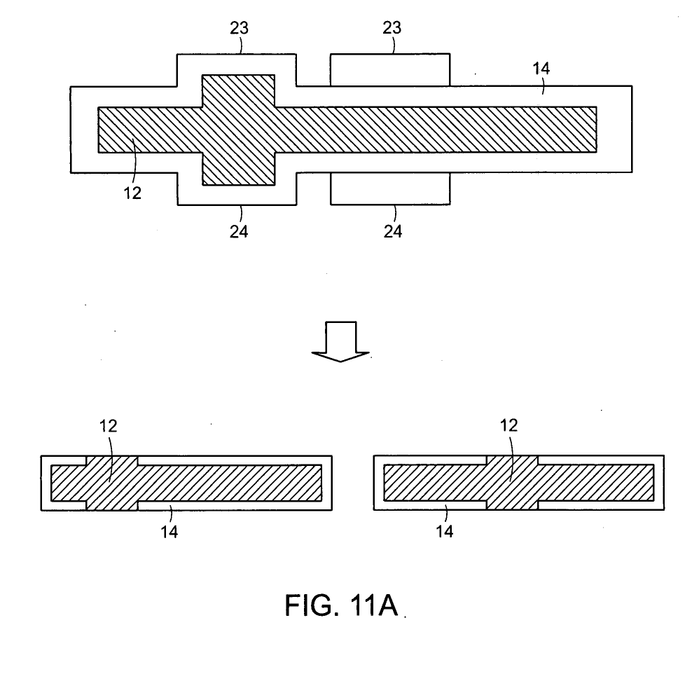

The method can, similarly be used to form the heating elements shown in FIGS. 10A-11B. In particular, as described above, a slip cast mold can be utilized of the general depicted configuration to provide a heating element body with one or more protruding regions 23 on the top surface 16, one or more protruding regions 24 on the bottom surface 18 (of course, any number and positioning of protrusions can be provided in addition to that depicted), and one or more protruding regions 26 on the side-faces 20, 21, 22. In one system, the slip cast mold is filled with an insulator ceramic composition. A rigid element may be provided by removal of binding agent(s). As generally illustrated in FIG. 11A, an encasing conductive outer layer 14 then can be applied around the slip cast insulator region 12. That conductive outer layer 14 may be applied e.g. by another slip casting application or other means such as dip coating to thereby form a heating element with two regions (12, 14) of differing resistivity. As shown by FIGS. 10B and 11B, one or more protruding regions 23, 24, and 26 then can be removed such as by machining to define an electrical pathway and provide a functional heating element. Such processing of the element body may be done with the element body in a green or sintered state. Thus, by processing of protrusions 23, 24, and 26, particularly removal thereof, the insulator inner region 12 bisects separated conductive outer region 14 which define an electrical pathway. In this illustration, the electrical pathway is a serpentine pathway as shown in FIG. 10B. In some embodiments, for example, as shown and discussed in connection with FIGS. 1F-1G, the electrical pathway includes one or more cold zones 14a, 14b, and one or more hot zones 14c through which the current flows. For example, one or more hot zones 14c and one or more cold zones 14a, 14b can be provided by any conventional methods such as, for example, dip coating. In some embodiments, the heating element is tapered along its length to provide increased resistance at those portions of the electrical pathway. In some embodiments, one or more additional portions of the heating element body can be processed to expose the inner region 12 further.

The above-described methods can similarly be used to form heating elements of any shape and having any desired electrical pathway. For example, while the figures generally show protrusions running along the center lengths of the top and bottom surfaces 16, 18 and the side faces 20, 21, 22, one or more protrusions can be positions at locations other than along the center of these faces 16, 18, 20, 21, 22 and/or running in directions other than along the lengths of these faces 16, 18, 20, 21, 22. Further, more than one or two protrusion can be provided on one or more of these faces 16, 18, 20, 21, 22. Other electrical pathway configurations can be provided, such as, for example, helical pathway which, like serpentine pathways, provide greater lengths and, thus, higher operational voltages.

Further, the above-described methods can similarly be used to form heating elements without the use of protrusions. For example, the general method can be applied except, instead of including and removing one or more projections to expose one or more portions of the inner region 12, a heating element can be provide without protrusions and, rather, one or more portions of the outer region 14 are removed (e.g. a layer of the outer region 14) in a desired pattern so as to expose the inner region and to define and electrical pathway.

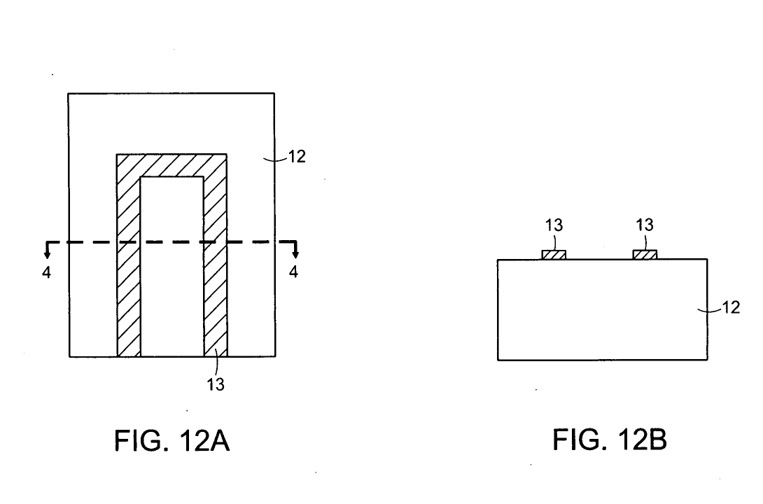

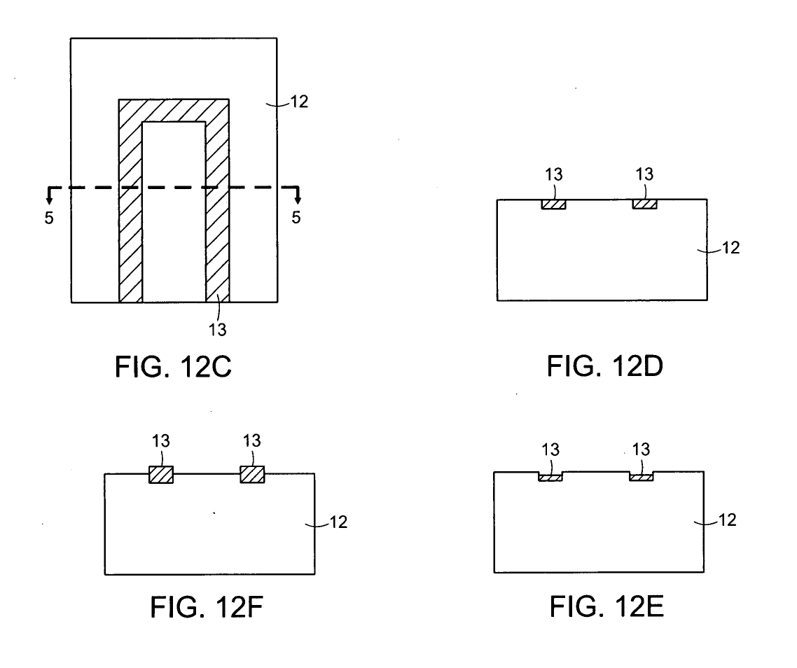

Further preferred fabrication methods are generally depicted in FIG. 12 A-F, where an inner or base region 12 having a first resistivity is formed in any desired shape. The inner or base region, in some embodiments, is a green insulating body. The inner or base region 12 can be formed using any conventional methods such as, for example, slip casting. extrusion molding, injection molding, and drain casting. A pattern is then deposited on at least one surface of the inner or base region 12 so as to provide a desired electrical pathway. In one embodiment, the pattern is embossed on at least one surface of the inner or base region 12, as generally depicted in FIG. 12 A-B. In another embodiment, the pattern is formed in a removed (channel) portion of the base region 12, as generally depicted in FIG. 12 C-E.

In either of such embodiments, the pattern is then filled in with a material having a second resistivity and the body is processed to form a surface pattern 13 on the inner or base region 12. In some embodiments, the pattern is filled by applying a slurry. One or more additional region(s) of differing resistivity can further be provided as desired using any suitable methods such as tape casting or dip coating. The thus formed heating element is formed with an inner or base region 12 having a first resistivity and a surface pattern 13 having a second resistivity, wherein an electrical circuit is defined on the surface of the inner or base region 12 exposed to the atmosphere. In some embodiments, the inner or base region 12 is an insulator region and the surface pattern 13 is a conductive region, wherein the conductive region defines the electrical pathway. Alternatively, the inner or base region 12 can be a conductive region and the surface pattern 13 can be an insulator region, wherein the inner or base region defines the electrical pathway. In some embodiments, sintering is performed at any suitable stage of the method to define the electrical pathway. In some embodiments, more than one electrical pathway can be provided on the inner or base region. For example, a first electrical pathway with specific characteristics can be provided on one portion of the inner or base region 12 using the methods set forth. One or more further independent electrical pathways each having their own specific characteristics can be provided on one or more further portions of the inner or base region 12. As such, a single heating element can be used in any variety of applications and can provide the required characteristics for any number of applications simply by selecting the appropriate electrical pathway to use. In some embodiments, the inner or base region 12 is provided with a plurality of surfaces and independent electrical pathways are provided on the plurality of surfaces.

While in certain embodiments described herein slip casting has been described as the approach to fabricate a heating element, other forming methods also may be suitably employed, either in addition to or entirely in place of slip casting. For instance, extrusion molding, injection molding, drain casting, and/or dip coating applications of ceramic compositions to form a heating element body and a formed (functional) heating element may be employed in accordance with conventional techniques. Extrusion molding to form a heating element is disclosed, for example, in International Publication WO 2006/050201. Injection molding to form a heating element is disclosed, for example, in International Publication WO 2006/086227. Dip coating applications are know and generally use a slurry or other fluid-like composition of the ceramic composition. The slurry may comprise water and/or polar organic solvent carriers such as alcohols and the like and one or more additives to facilitate the formation of a uniform layer of the applied ceramic composition. For instance, the slurry composition may comprise one or more organic emulsifiers, plasticizers, and dispersants. Those binder materials may be suitably removed thermally during subsequent densification of the heating element.

In accordance with the present methods, further regions of distinct resistivity also may be included into the heating element body such as through dip coating or other application method. For instance, for certain systems, it may be desirable to include a power booster or enhancement zone of intermediate resistance in the electrical circuit pathway between the most conductive portions of that pathway and the highly resistive (hot) regions of that pathway. Such booster zones of intermediate resistance are described in U.S. Patent application Publication 2002/0150851 to Willkens. Generally, booster zones will have a positive temperature coefficient of resistance (PTCR) and an intermediate resistance that will permit i) effective current flow to a hot zone, and ii) some resistance heating of the booster region during use of the igniter, although preferably the booster zone will not heat to as high temperatures as the hot zone during use of the heating element.

If employed in a heating element, preferred booster zone compositions may comprise the same materials as the conductive and hot zone region compositions, e.g. preferred booster zone compositions may comprise e.g. AIN and/or Al₂O₃, or other insulating material; SiC or other semiconductor material; and MoSi₂ or other conductive material. A booster zone composition typically will have a relative percentage of the conductive and semiconductive materials (e.g., SiC and MoSi₂) that is intermediate between the percentage of those materials in the hot and cold zone compositions. A preferred booster zone composition comprises about 60 to 70 v/o aluminum nitride, aluminum oxide, or other insulator material; and about 10 to 20 v/o MoSi₂ or other conductive material, and balance a semiconductive material such as SiC. A specifically preferred booster zone composition for use in igniters of the invention contains 14 v/o MoSi₂, 20 v/o SiC and balance v/o Al₂O₃. A specifically preferred booster zone composition for use in igniters of the invention contains 17 v/o MoSi₂, 20 v/o SiC and balance Al₂O₃. A further specifically preferred booster zone composition for use in igniters of the invention contains 14 v/o MoSi₂, 20 v/o SiC and balance v/o AIN. A still farther specifically preferred booster zone composition for use in igniters of the invention contains 17 v/o MoSi₂, 20 v/o SiC and balance AIN.

In some embodiments, the heating element is provided with additional functions such as a thermocouple circuit, flame sensor or flame rectifier.

Further, in certain embodiments, the heating element is further provided with a resistive heating region of a distinct ceramic composition. For instance, a heating element may comprise conductive, hot (resistive heating) and insulator regions (i.e. a three region system), where each of such regions has a differing ceramic composition.

The methods of the present invention and the thus formed ceramic heating elements provide numerous benefits including enhanced design flexibility, reduced fabrication costs, a proven and effective method for forming a strong interface between layers of different resistivity (e.g. conductive, resistor, and insulator layers), elimination of issues encountered using embossing, tape-casting, binder removal, and other techniques, and fewer restrictions on usable material systems and compositions. The heating elements are further provided with ruggedness, good oxidation resistance, and fast TTT (time to temperature) and ignition. For example, by providing an insulating region as an inner region 12 which supports the conductive outer region 14 forming the electrical pathway, greater mechanical strength is provided. Exposure of the electrical pathway provides for faster TTT and ignition. The ceramic heating elements are useful in a variety of applications, such as gas phase fuel ignition applications such as furnaces and cooking appliances, baseboard heaters, boilers, and stove tops. In particular, a heating element of the invention may be used as an ignition source for stove top gas burners as well as gas furnaces. Heating elements of the invention also are particularly suitable for use for ignition where liquid (wet) fuels (e.g. kerosene, gasoline) are evaporated and ignited, e.g. in vehicle (e.g. car) heaters that provide advance heating of the vehicle. Heating elements of the invention also are suitably employed as glow plugs, e.g. as an ignition source in a motor vehicle such as an automobile, truck, watercraft and the like. Heating elements of the invention will be useful for additional specific applications, including as a heating element for an infrared heater and as sensors.

In use, power can be supplied to heating element 10 (e.g. via one or more electrical leads, not shown) through proximal ends of the conductive regions. Electrical leads may be affixed to proximal ends such as through brazing. The heating element proximal end suitably may be mounted within a variety of fixtures, such as where a ceramoplastic sealant material encases conductive element proximal ends. Such encasing with a sealant material is disclosed in U.S. Pat. No. 6,933,471. Metallic fixtures also may be suitably employed to encase the heating element proximal end.

The following non-limiting example is illustrative of the invention. All documents mentioned herein are incorporated herein by reference in their entirety.

### Example 1

A bilayer wedge-shape part was prepared by drain-casting the outer conductive layer and slip-casting the inner insulating layer. In the green state, two opposing faces were machined away forming an electrical path. The part was then hot-densified by pressureless sintering at 1770 C-3 h and hot isostatic pressing at 1750 C at 30 ksi. The part could be energized at 120V to 1350° C. drawing about 120 watts.

The invention has been described in detail with reference to particular embodiments thereof. However, it will be appreciated that those skilled in the art, upon consideration of this disclosure, may make modification and improvements within the spirit and scope of the invention.

1. A method for producing a resistive ceramic heating element, comprising:
forming a heating element body comprising an inner region and an outer region, wherein the inner region and outer region have differing resistivities and wherein the inner region is substantially encapsulated by the outer region;
processing the heating element body so as to expose at least a portion of the inner region, thereby defining an electrical pathway exposed to the atmosphere.

2. The method of claim 1, wherein the inner region comprises at least one insulator material and the outer region comprises at least one conductive material.

3. The method of claim 2, wherein exposure of at least a portion of the inner insulator region separates the outer conductive region, thereby providing an electrical pathway on the outer conductive region.

4. The method of claim 3, further comprising exposing at least a further portion of the inner insulator layer to lengthen the electrical pathway.

5. (canceled)

6. The method of claim 3, further comprising providing a one or more further regions of differing resistivity within the electrical pathway to thereby define one or more cold zones and one or more hot zones.

7. The method of claim 1, wherein processing comprises removing one or more portions of the outer region.

8. The method of claim 1, wherein the heating element body is formed with one or more protruding sections, and wherein processing comprises removing one or more protruding sections of the heating element body.

9. The method of claim 1, wherein the heating element has a substantially square or rectangular cross-sectional shape for at least a portion of the heating element length.

10. The method of claim 9, wherein the inner region is exposed so as to form a serpentine electrical pathway on at least a top and/or bottom surface of the heating element.

11. (canceled)

12. The method of claim 10, wherein the serpentine electrical pathway is formed on both the top and bottom surfaces of the heating element and the inner region is further exposed along a portion of at least one side surface to provide an electrical pathway that extends from the top surface to the bottom surface.

13. (canceled)

14. A method for producing a resistive ceramic heating element, comprising:
forming a base region, the base region having a first resistivity;
depositing a heating element pattern on one or more surfaces of the base region;
forming the pattern with a material having a second resistivity different than the first resistivity;
whereby an electrical pathway is defined by the pattern of material having the second resistivity separated by the base region material having the first resistivity, and whereby the electrical pathway is exposed to the atmosphere.

15. The method of claim 14, wherein the base region is formed of at least one insulator material and the pattern is formed of at least one conductive material, and wherein the pattern defines the electrical pathway.

16. The method of claim 14, wherein the heating element pattern is deposited by embossing.

17. The method of claim 14, wherein the pattern is filled with a slurry and processed to provide a surface pattern disposed on the base region.

18. A heating element body comprising:
an inner region having a first resistivity;
an outer region substantially encapsulating the inner region, the outer region having a second resistivity;
wherein at least portions of the inner region are exposed on one or more surfaces of the heating element body, thereby defining an electrical pathway exposed to the atmosphere.

19. The heating element body of claim 18, wherein the inner region is formed of at least one insulator material and the outer region is formed of at least one conductive material, wherein the outer region is separated by the exposed inner region to thereby define the electrical pathway.

20. A heating element body comprising:
a base region having a first resistivity;
a surface pattern disposed on at least one surface of the base region, the surface pattern having a second resistivity;
wherein an electrical pathway is defined on at least one surface of the heating element body by the differing resistivities in the base region and the surface pattern.

21. The heating element of claim 20, wherein the base region is formed of an insulator material and the surface pattern is formed of a conductive material, and wherein the electrical pathway is defined on the surface pattern.

22. The heating element of claim 20, wherein the base region is provided with two or more independent electrical pathways with different characteristics.

23. The heating element of claim 22 wherein independent electrical pathways are provided on different surfaces of the base region.

24. A heating element body comprising two or more regions of differing resistivities and two or more independent electrical pathways, wherein the two or more electrical pathways are provided with different characteristics.

25. (canceled)

26. The heating element of claim 24, wherein the heating element body has a rectangular shape and wherein independent electrical pathways are disposed on different surfaces of the heating element body.

27. (canceled)

28. (canceled)

29. A method of igniting gaseous fuel, comprising applying an electric current across a heating element of claim 18.

30. (canceled)

31. A heating apparatus comprising a heating element of claim 18.
